(19) United States
(12) Patent Application Publication
(10) Pub. No.: US 2006/0256670 A1
(43) Pub. Date: Nov. 16, 2006

(54) Signal-to-noise ratio measurement apparatus and method for signal read out of optical disc

(75) Inventors: Hyun-soo Park, Seoul (KR); Jae-seong Shim, Anyang-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/377,192

(22) Filed: Mar. 17, 2006

(30) Foreign Application Priority Data
May 16, 2005 (KR) 2005-40666

(51) Int. Cl. G11B 21/10

(52) U.S. Cl. 369/43

(57) ABSTRACT

A signal-to-noise ratio measurement apparatus for a signal read from an optical disc comprises a storage unit for storing an input signal read from an optical disc; an index signal detection unit for detecting an index signal enabling repetition signals to be identified, the repetition representing an input signal that is continuously repeated in a certain interval; and a calculation unit for reading the repetition signals stored in the storage unit based on the index signal, detecting an original signal indicating an average value of the repetition signals, detecting noise contained in the repetition signals based on a difference value between the original signal and the repetition signals, and calculating a signal-to-noise ratio of the input signal based on the original signal and noise. Accordingly, the apparatus measures the quality of an optical disc by calculating a signal-to-noise ratio of an input signal continuously repeated, thereby enabling the quality of the optical disc to be measured even when jitter can not be detected due to the high recording density of the optical disc.

### CROSS-REFERENCE TO RELATED APPLICATIONS

This application claims all benefits accruing under 35 U.S.C. § 119 from Korean Patent Application No. 2005-40666, filed May 16, 2005, in the Korean Intellectual Property Office, the disclosure of which is incorporated by reference herein.

### BACKGROUND OF THE INVENTION

1. Field of the Invention

The present invention relates to a measurement apparatus and method for processing a signal read out of an optical disc, and more particularly, to a signal-to-noise ratio measurement apparatus and method for a signal read out of an optical disc, capable of measuring a signal-to-noise ratio by detecting a noise-removed original signal based on, out of a signal read from an optical disc, signals continuously repeated in a certain interval (hereinafter, referred to as repetition signals).

2. Related Art

Generally, an information storage medium such as an optical disc is used to record a binary signal on the surface thereof and to reproduce data therefrom, based on a waveform reflected when a laser beam is incident thereon. Typically, a signal read from the surface of an optical disc is a radio frequency (RF) signal. Even though a binary signal is recorded on the surface of the optical disc, an RF signal read from such an optical disc has the characteristics of an analog signal, rather than those of a binary signal. This is due to disc properties and optical characteristics. As a result, a binarization process is needed to convert an analog signal into a digital signal for further processing.

FIG. 1 illustrates an example apparatus for binarizing (or slicing) a signal read from an optical disc. As shown in FIG. 1, such an apparatus is provided with a comparison unit 10, a low-pass filter 20, a Phase Locked Loop (PLL) 30, and a signal-processing unit 40.

The comparison unit 10 receives an RF signal read from an optical disc, and compares the RF signal with a reference voltage. If the RF signal is higher than the reference voltage, the comparison unit 10 outputs a signal of “1” to the signal-processing unit 40. Alternatively, if the RF signal is lower than the reference voltage, the comparison unit 40 outputs a signal of “0” to the signal-processing unit 40. That is, the comparison unit 10 converts the RF signal as an analog signal into a digital signal, and outputs the digital signal to the signal-processing unit 40.

The low-pass filter 20 generates the reference voltage used by the comparison unit 10, using the RF signal outputted from the comparison unit 10.

The signal-processing unit 40 signal-processes the digital (slice) signal outputted from the comparison unit 10 so that information such as a video signal or an audio signal recorded on the optical disc can be reproduced.

The PLL 30 compensates for a reference clock used by the signal-processing unit 40 so that the signal-processing unit 40 can read a digital (slice) signal inputted from the comparison unit 10 according to the reference clock.

FIG. 2 is a graphical view of a conventional method for measuring an error of a signal read from an optical disc by using jitter. In general, a method used for measurement of an error of an RF signal read from an optical disc is to numerically express how many integer times a digital signal representing an RF signal is longer than a pit length on an optical disc. Such a numerical value is referred to as jitter. As a waveform of an RF signal is closer to integer times the pit length at the time the waveform of the RF signal is recorded on an optical disc, the probability for a recorded signal to be judged as an error signal becomes more lowered when a signal recorded on the optical disc is reproduced.

As shown in FIG. 2, an RF signal R1 is larger in magnitude than a reference voltage of the comparison unit 10 for a time period of t1 to t3 during a time period 2T, which is two times the unit length of a pit length. However, out of the time period of 2T, a reference clock exists from t1 to t4 in order for the signal to be read from the optical disc. Accordingly, jitter occurs during time intervals as much as (t2-t1) and (t4-t3) over the duration of the RF signal R1. When the time jitter is high, the RF signal R1 is not judged as “1”, but is judged as an error signal.

Turning now to FIGS. 3A and 3B, example views of an RF signal read from a low-density optical disc and an RF signal read from a high-density optical disc, respectively, are shown. Specifically, FIG. 3A shows an RF signal read from a low-density optical disc from a time interval A to a time interval B. FIG. 3B shows an RF signal read from a high-density optical disc from a time interval A′ to a time interval B′. As for an identical RF signal, FIGS. 3A and 3B show an RF signal read from a low-density optical disc and an RF signal read from a high-density optical disc, respectively.

As shown in FIGS. 3A and 3B, in view of RF signals in time intervals A and A′, an RF signal read from a low-density disc has distinct signal portions higher and lower than a reference voltage since the RF signal is recorded in a pit length relatively long compared to the same signal recorded on a high-density disc. However, as for the same signal, an RF signal shown in FIG. 3B read from a high-density disc has values lower than the reference voltage in contrast to the RF signal read from the low-density disc. Accordingly, the RF signal recorded on the high-density disc in a time interval A′ has to be outputted as “1” when binarized, but the RF signal can still be judged as an error signal when reproduced.

Further, in view of an RF signal read in a time interval B′, shown in FIG. 3B, an RF signal read from a low-density disc has distinct signal portions lower and higher than a reference voltage as the RF signal read in the time interval A′, so the read RF signal can be binarized without an error. However, even though there exists a region in the time interval B′ in which the RF signal read from a high-density disc has a value higher than the reference voltage, the distinct signal portion is recorded in a short unit length on an optical disc so as to be read as a distinct signal portion lower than the reference voltage. Accordingly, the RF signal in the time interval B′ can be judged as an error signal when reproduced.

As described in connection with FIGS. 3A and 3B, as the recording density of an optical disc is getting higher, a signal is recorded in a shorter unit length, and, if the recording density is over a certain level, signals can be generated which fails to satisfy a binarization level. Since signal portions occur which fails to satisfy a binarization level as the RF signal in the time intervals A′ and B′ shown in FIG. 3B, jitter as described in connection with FIG. 2 cannot be obtained.

### SUMMARY OF THE INVENTION

Various aspects and example embodiments of the present invention provide a signal-to-noise ratio measurement apparatus and method for a signal read from an optical disc, capable of measuring a signal-to-noise ratio of an input signal by obtaining an average value of repetition signals, which are continuously repeated, of an input signal in certain intervals and detecting a noise-removed input signal, rather than using jitter, in order to measure the quality of an input signal read from an optical disc.

Additional aspects and/or advantages of the invention will be set forth in part in the description which follows and, in part, will be obvious from the description, or may be learned by practice of the invention.

In accordance with an aspect of the present invention, a signal-to-noise ratio measurement apparatus for a signal read from an optical disc, comprises a storage unit for storing an input signal read from an optical disc; an index signal detection unit for detecting an index signal enabling repetition signals to be identified, the repetition signals representing an input signal that is continuously repeated in a certain interval; and a calculation unit for reading the repetition signals stored in the storage unit based on the index signal, detecting an original signal indicating an average value of the repetition signals in which noise is removed, detecting noise contained in the repetition signals based on a difference value between the original signal and the repetition signals, and calculating a signal-to-noise ratio of the input signal based on the original signal and the noise.

The calculation unit comprises an original signal detection unit for re-arranging the repetition signals in the certain interval in which the input signal is continuously repeated, calculating an average value of the re-arranged repetition signals, and detecting the original signal of a noise-removed repetition signal; a noise detection unit for detecting noise of the repetition signals based on a difference between the original signal and the repetition signals; and a signal-to-noise ratio calculation unit for calculating a signal-to-noise ratio of the input signal, based on the original signal and the noise.

The signal-to-noise ratio calculation unit calculates the signal-to-noise ratio of the input signal, using an equation as below:
SNR=10 log₁₀(average_{sig})²/(average_{sig}−input_{sig})²,

wherein SNR denotes the signal-to-noise ratio of the input signal, average_{sig} denotes the original signal as an average value of the repetition signals, and input_{sig} denotes the repetition signal.

In accordance with another aspect of the present invention, a signal-to-noise ratio measurement method for a signal read from an optical disc, comprises storing an input signal read from an optical disc in a storage; detecting an index signal enabling repetition signals to be identified, the repetition signal representing an input signal that is continuously repeated in a certain interval; reading the repetition signals stored in the storage based on the index signal; and detecting an original signal that is an average value of the repetition signals, detecting noise of the repetition signals based on a difference value between the original signal and the repetition signals, and calculating a signal-to-noise ratio of the input signal by using the original signal and the noise.

The signal-to-noise ratio is calculated by re-arranging the repetition signals in the certain interval in which the input signal is continuously repeated; detecting the original signal of the noise-removed repetition signal based on an average value of the repetition signals; detecting noise of the repetition signals based on a difference between the original signal and the repetition signals; and calculating the signal-to-noise ratio of the input signal based on the original signal and the noise.

Specifically, the signal-to-noise ratio is calculated based on an equation as below:
SNR=10 log₁₀(average_{sig})²/(average_{sig}−input_{sig})²,

wherein SNR denotes the signal-to-noise ratio of the input signal, average_{sig} denotes the original signal as an average value of the repetition signals, and input_{sig} denotes the repetition signal.

In accordance yet another aspect of the present invention, a measurement apparatus is provided with a storage to store an input signal read from an optical disc; and a controller configured to obtain an index signal enabling repetition signals to be identified, to read the repetition signals stored in the storage based on the index signal, to detect an original signal indicating an average value of the repetition signals, to detect noise contained in the repetition signals, and to calculate a signal-to-noise ratio of the input signal based on the original signal and the noise, wherein the repetition signals represent an input signal that is continuously repeated in a designated interval.

The controller is provided with an index detection unit for detecting the index signal; an original signal detection unit for re-arranging the repetition signals in the designated interval in which the input signal is continuously repeated, for calculating an average value of the re-arranged repetition signals, and for detecting the original signal of a noise-removed repetition signal; a noise detection unit for detecting noise of the repetition signals based on a difference between the original signal and the repetition signals; and a signal-to-noise ratio calculation unit for calculating a signal-to-noise ratio of the input signal, based on the original signal and the noise obtained.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an example apparatus for binarizing a signal read from an optical disc;

FIG. 2 is a graphical view of a conventional method for measuring an error of a signal read from an optical disc by using jitter;

FIGS. 3A and 3B are views for showing an RF signal read from a low-density optical disc and an RF signal read from a high-density optical disc, respectively;

FIG. 4 is a block diagram of an example signal-to-noise ratio measurement apparatus for a signal read from an optical disc according to an embodiment of the present invention;

FIG. 5 is a flow chart of an example signal-to-noise ratio measurement method for a signal read from an optical disc according to an embodiment of the present invention; and

FIGS. 6A to 6D are views for explaining a signal-to-noise ratio measurement method shown in FIG. 5.

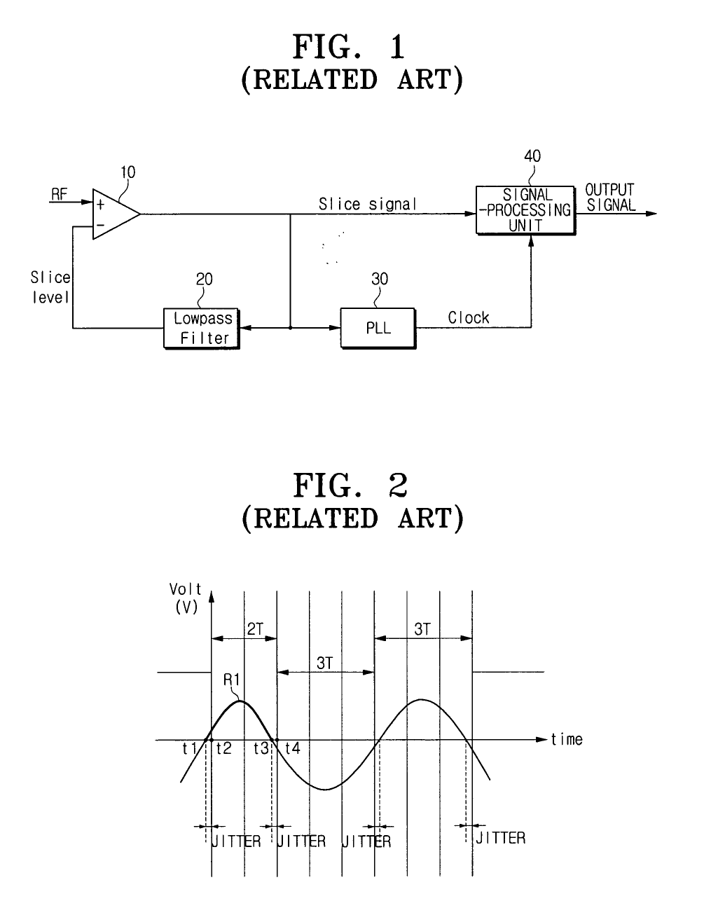

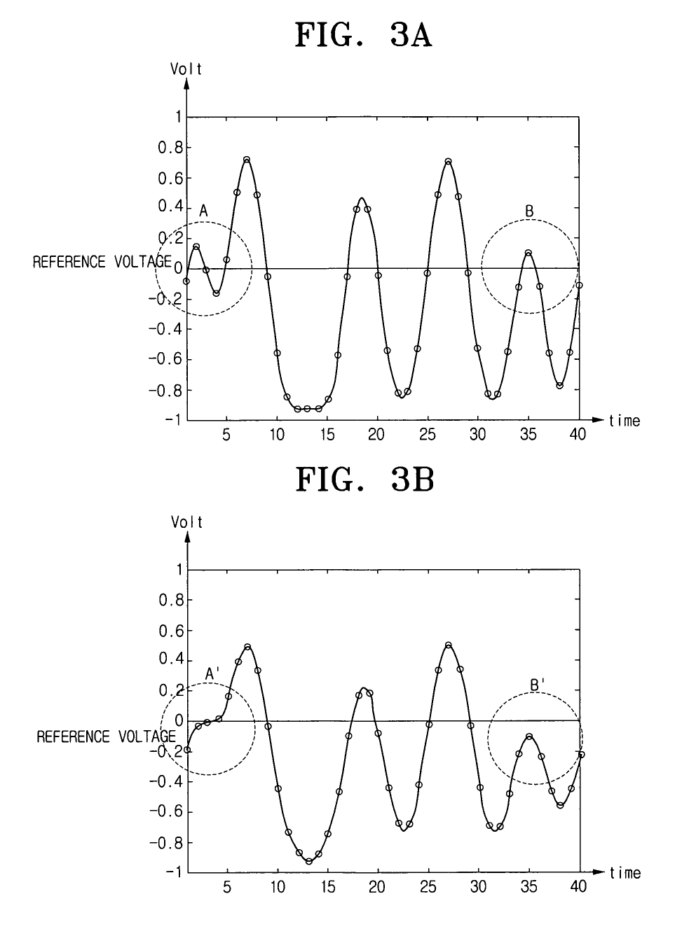

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

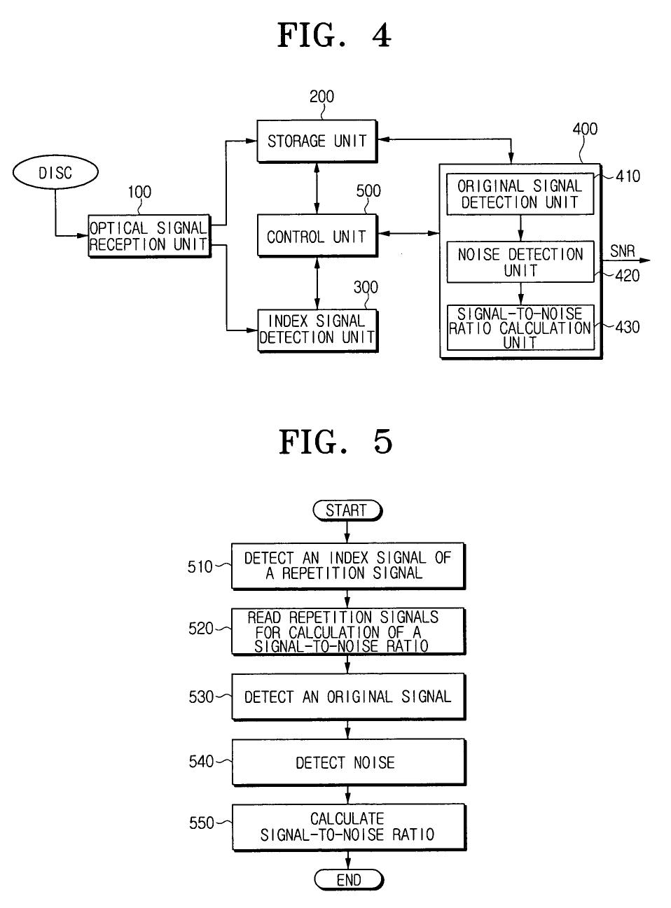

FIG. 4 is a block diagram of an example signal-to-noise ratio measurement apparatus for a signal read from an optical disc according to an embodiment of the present invention. As shown in FIG. 4, the signal-to-noise ratio measurement apparatus comprises an optical signal reception unit 100, a storage unit 200, an index signal detection unit 300, a calculation unit 400, and a control unit 500.

The optical signal reception unit 100 receives an RF signal as an input signal read from an optical disk. The optical signal reception unit 100 detects light reflected from the surface of an optical disc through photo diodes thereof, and converts an electrical current outputted from the photo diodes into voltages. Next, the optical signal reception unit 100 RF-sums the converted voltage signals, converts the RF-summed signals into a quantized digital signal.

The storage unit 200 stores the quantized digital signal outputted from the optical signal reception unit 100.

The index signal detection unit 300 detects an index signal for enabling repetition signals of an input signal in a continuously repeated interval to be identified. The repetition signals represent an input signal that is continuously repeated in a certain interval. These repetition signals are signal portions used for calculations for a signal-to-noise ratio of an input signal read from an optical disc. The index signal represents a signal added to each repeated interval in which repetition signals appear. Further, the index signal is a unique signal in an interval in which repetition signals appear, and the index signal detection unit 300 can detect repetition signals of an input signal by detecting the index signal.

The calculation of a signal-to-noise ratio based on repetition signals can result in “0” as a sum of noise over the repetition signals in a certain interval when an average value is calculated over the repetition signals. Accordingly, noise contained in a repetition signal can be detected through detection of an original signal from a noise-removed repetition signal, and the detection of noise enables a signal-to-noise ratio to be measured.

The index signal is a signal longer than a basic unit length for data recording on an optical disc, and can be added to each repeated interval in which repetition signals occur. As for an optical disc, the run-length limited (RLL) code is used for data recording, which has limitations as to the minimum and maximum lengths in general. As for a DVD, only a signal having a length of 3T to 11T is used, but a signal of 14T longer than the basic length of 3T to 11T can be added as an index for identifying a repetition signal.

The control unit 500 controls the overall operation of constituent components, including the optical signal reception unit 100, the storage unit 200, the index signal detection unit 300, and the calculation unit 400. Specifically, the control unit 500 controls an output of a signal corresponding to the repetition signal of an input signal stored in the storage unit 200 using an index signal detected by the index signal detector 300.

The calculation unit 400 includes an original signal detection unit 410, a noise detection unit 420, and a signal-to-noise ratio calculation unit 430, and calculates a signal-to-noise ratio of an input signal, using an original signal and a repetition signal.

The original signal detection unit 410 receives from the storage unit 200 a repetition signal detected based on an index signal detected by the index signal detection unit 300. Further, the original signal detection unit 410 re-arranges the repetition signals in an interval in which the same repetition signals are repeated, and calculates an average value of the re-arranged repetition signals. If noise contained in the repetition signals has no relations with one another, the average value of noise contained in repetition signals of a certain interval can be considered as “0”. Accordingly, the average value of the re-arranged repetition signals can be an original signal for noise-removed repetition signals.

The noise detection unit 420 detects noise contained in a repetition signal based on a difference between an original signal detected by the original signal detection unit 410 and the repetition signals used for calculation of a signal-to-noise ratio of an input signal and stored in the storage unit 200.

The signal-to-noise ratio calculation unit 430 calculates a signal-to-noise ratio of an input signal by calculating a ratio of an original signal to noise detected by the noise detection unit 420. As previously described, the original signal is an average value of the re-arranged repetition signals which is calculated by the original signal detection unit 410. In turn, the signal-to-noise ratio of the input signal is calculated based on Equation 1 as below.
SNR=10 log₁₀(signal power)/(noise power)=10 log₁₀(average_{sig})²/(average_{sig}−input_{sig})²=10 log₁₀(average_{sig})²/(noise)² [Equation 1]

wherein SNR (Signal-to-Noise Ratio) represents a signal-to-noise ratio of an input signal, average_{sig} represents the original signal as an average value of repetition signals which is calculated by the original signal detection unit 410, and input_{sig} represents the repetition signals used for detection of the original signal. Further, noise represents noise contained in a repetition signal.

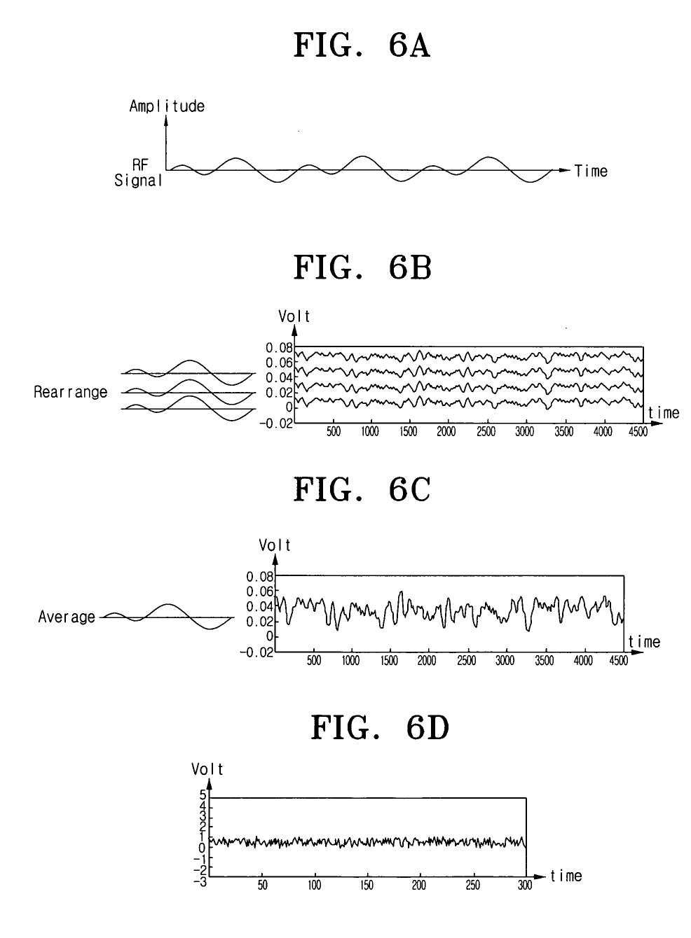

FIG. 5 is a flow chart of an example signal-to-noise ratio measurement method for a signal read from an optical disc according to an embodiment of the present invention. FIGS. 6A to 6D are views for explaining in detail the signal-to-noise ratio measurement method shown in FIG. 5. Specifically, FIG. 6A shows an RF signal read from an optical disc; FIG. 6B shows the re-arrangement of repetition signals in individual intervals repeated; FIG. 6C shows an average value of re-arranged repetition signals; and FIG. 6D shows how noise is obtained based on a difference between an original signal which is an average value of re-arranged repetition signals and a repetition signal.

Referring now to FIG. 5, the signal-to-noise ratio measurement method is performed by the signal-to-noise measurement apparatus shown in FIG. 4. In particular, the signal-to-noise measurement apparatus, as shown in FIG. 4, quantizes and stores an RF signal as an input signal read from an optical disc, and detects an index signal distinct from a repetition signal which is an input signal that is continuously repeated in a certain interval at block 510.

Specifically, the optical signal reception unit 100 detects and converts a laser beam reflected from the surface of an optical disc into a voltage, and performs RF-summing, quantizes, and stores the RF-summed signal in a digital form in the storage unit 200. The RF-summed signal is shown in FIG. 6A. Further, the index signal detection unit 300 detects an index signal for enabling repetition signals to be identified, such that the repetition signals are used to calculate a signal-to-noise ratio of an input signal read from an optical disc. As previously discussed, the index signal is a signal added to each repeated intervals in which repetition signals appear, and is a unique signal in an interval repeated. Accordingly, the repetition signals of an input signal can be detected through detection of an index signal.

Further, the index signal is a signal longer than a basic length for unit data for recording on an optical disc, and can be added to an input signal in individual intervals repeated. As for an optical disc, data is generally recorded by the run-length limited (RLL) code which limits the maximum length and the minimum length. As for a DVD, only a signal having a length of 3T to 11T is used, and an index signal can be added for identifying an input signal of a certain interval as a signal of 14T longer than the basic length of 3T to 11T.

Next, the signal-to-noise measurement apparatus, as shown in FIG. 4, then reads out a stored input signal in the form of repetition signals used for calculation of a signal-to-noise ratio of an input signal at block 520. Specifically, the control unit 500 uses an index signal to detect from the stored input signal a repetition signal used for calculation of a signal-to-noise ratio. At the time an index signal for a repetition signal is detected, the control unit 500 can read out from the stored input signal the repetition signal corresponding to the index signal, since the index signal is unique data in the repeated interval.

Next, the signal-to-noise measurement apparatus, as shown in FIG. 4, calculates an average value of repetition signals read based on the index signal, and detects an original signal of a repetition signal at block 530. The original signal refers to a noise-removed repetition signal. For the detection of the original signal, the repetition signals are re-arranged in individual intervals repeated, and an average value of the re-arranged repetition signals are calculated. FIG. 6B shows the re-arrangement of repetition signals in individual intervals repeated, and FIG. 6C shows an average value of the re-arranged repetition signals.

If noise contained in the repetition signals that are continuously repeated in a certain interval has no relation with one another, an average value of the noise contained in the repetition signals can be considered as “0”. Accordingly, an original signal can be detected through removal of noise from repetition signals based on an average value of the re-arranged repetition signals.

Next, the signal-to-noise measurement apparatus, as shown in FIG. 4, detects noise contained in the repetition signals based on the original signal and the repetition signals used for the detection of the original signal at block 540. Specifically, the calculation unit 600 responsive to the control unit 500 detects noise contained in the repetition signals by calculating differences between the original signal and the repetition signals used for the detection of the original signals. Noise of a repetition signal is obtained from subtraction of a noise-carrying repetition signal from an original signal of a noise-free repetition signal. Accordingly, the calculation unit 400 detects noise by calculating a difference between an original signal and a repetition signal.

Noise of a repetition signal is detected, as shown in FIG. 6D, from a difference between an original signal of a noise-removed repetition signal as shown in FIG. 6C and a noise-carrying repetition signal as shown in FIG. 6B.

Next, the calculation unit 400 calculates a signal-to-noise ratio of an input signal by calculating a ratio of an original signal obtained at block 530 to noise detected at block 540. As previously discussed, the original signal is an average value of repetition signals corresponding to an original signal detected at block 530. The signal-to-noise ratio is calculated based on Equation 1 as discussed above.

Accordingly, an original signal of a noise-removed repetition signal is detected, out of an input signal read from an optical disc, based on the repetition signals that are continuously repeated in a certain interval, and can be used as an index for evaluation of the overall characteristics of an optical disc.

Further, a signal-to-noise ratio of an input signal is calculated based on original signals of repetition signals, and can be used at the time an index for evaluation of the characteristics of an over optical disc, disc tilt, and an extent of focusing are optimized. That is, the extent of the optical disc tilt and focusing can be adjusted for reduction of a signal-to-noise ratio. Further, the recording characteristics can be optimized based on the calculated signal-to-noise ratio if an optical disc is a writable disc.

As described above, based on an input signal read from an optical disc, the present invention measures the quality of an optical disc by calculating a signal-to-noise ratio of repetition signals that are continuously repeated in a certain interval, thereby enabling the quality of the optical disc to be measured even if jitter can not be detected since the optical disc has a high recording density. As a result, the present invention can measure the quality of an optical disc using the pit space or mark lower than a certain resolution.

Further, in order to calculate a signal-to-noise ratio of an input signal, the present invention can detect the characteristics of a noise-removed original signal by detecting a noise-free input signal. Furthermore, out of an input signal read from an optical disc, the present invention can detect noise of an input signal by using repetition signals that are continuously repeated in a certain interval, and numerically and objectively detect signals of noise components.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, an optical disc can be any recording medium, including DVD, DVD-R, DVD-RW, DVD+RW, DVD-RAM, DVD-ROM, CD, CD-R, CD-RW, and CD-ROM, or alternatively, any high-density medium, such as blue-ray disc (BD) and advanced optical disc (AOD). Similarly, a control unit can be implemented as a chipset having firmware, or alternatively, a general or special purposed computer programmed to perform the methods as described, for example, with reference to FIG. 5. Accordingly, it is intended, therefore, that the present invention not be limited to the various example embodiments disclosed, but that the present invention includes all embodiments falling within the scope of the appended claims.

What is claimed is:

1. A signal-to-noise ratio measurement apparatus comprising:
a storage unit to store an input signal read from an optical disc;
an index signal detection unit arranged to detect an index signal enabling repetition signals to be identified, the repetition signals representing an input signal that is continuously repeated in a designated interval; and
a calculation unit arranged to read the repetition signals stored in the storage unit based on the index signal, to detect an original signal from which noise as an average value of the repetition signals is removed, to detect noise contained in the repetition signals, and to calculate a signal-to-noise ratio of the input signal based on the original signal and the noise.

2. The apparatus as claimed in claim 1, wherein the calculation unit comprises:
an original signal detection unit for re-arranging the repetition signals in the designated interval in which the input signal is continuously repeated, for calculating an average value of the re-arranged repetition signals, and for detecting the original signal of a noise-removed repetition signal;
a noise detection unit for detecting noise of the repetition signals based on a difference between the original signal and the repetition signals; and
a signal-to-noise ratio calculation unit for calculating a signal-to-noise ratio of the input signal, based on the original signal and the noise.

3. The apparatus as claimed in claim 2, wherein the signal-to-noise ratio calculation unit calculates the signal-to-noise ratio of the input signal, using the following equation:
SNR=10 log₁₀(average_{sig})²/(average_{sig}−input_{sig})²,
wherein SNR represents the signal-to-noise ratio of the input signal, averaged represents the original signal as an average value of the re-arranged repetition signals, and input_{sig} represents the repetition signals used for detecting the original signal.

4. A signal-to-noise ratio measurement method for a signal read from an optical disc, comprising:
storing an input signal read from an optical disc in a storage;
detecting an index signal enabling repetition signals to be identified, the repetition signals representing an input signal that is continuously repeated in a designated interval;
reading the repetition signals stored in the storage based on the index signal; and
detecting an original signal representing an average value of the repetition signals, detecting noise of the repetition signals based on a difference value between the original signal and the repetition signals, and calculating a signal-to-noise ratio of the input signal based on the original signal and the noise.

5. The method as claimed in claim 4, wherein the signal-to-noise ratio is calculated by:
re-arranging the repetition signals in the designated interval in which the input signal is continuously repeated, and detecting the original signal of the noise-removed repetition signal based on an average value of the repetition signals;
detecting noise of the repetition signals based on a difference between the original signal and the repetition signals; and
calculating the signal-to-noise ratio of the input signal based on the original signal and the noise.

6. The method as claimed in claim 5, wherein the signal-to-noise ratio is calculated based on the following equation:
SNR=10 log₁₀(average_{sig})²/(average_{sig}−input_{sig})²,
wherein SNR represents the signal-to-noise ratio of the input signal, average_{sig} represents the original signal as an average value of the re-arranged repetition signals, and input_{sig} represents the repetition signals used for detecting the original signal.

7. The apparatus as claimed in claim 1, wherein the index signal is a unique signal longer than a basic length of unit data that is added to each repeated intervals in which repetition signals occur.

8. The apparatus as claimed in claim 1, wherein the signal-to-noise ratio calculation unit calculates the signal-to-noise ratio of the input signal, using the following equation:
SNR=10 log₁₀(average_{sig})²/(noise)²,
wherein SNR represents the signal-to-noise ratio of the input signal, averages represents the original signal as an average value of the re-arranged repetition signals, and noise represents noise contained in the repetition signals.

9. The method as claimed in claim 4, wherein the index signal is a unique signal longer than a basic length of unit data that is added to each repeated intervals in which repetition signals occur.

10. The method as claimed in claim 4, wherein the signal-to-noise ratio of the input signal is calculated using the following equation:
SNR=10 log₁₀(average_{sig})²/(noise)²,
wherein SNR represents the signal-to-noise ratio of the input signal, average_{sig} represents the original signal as an average value of the re-arranged repetition signals, and noise represents noise contained in the repetition signals.

11. A measurement apparatus comprising:
a storage to store an input signal read from an optical disc; and
a controller configured to obtain an index signal enabling repetition signals to be identified, to read the repetition signals stored in the storage based on the index signal, to detect an original signal indicating an average value of the repetition signals, to detect noise contained in the repetition signals, and to calculate a signal-to-noise ratio of the input signal based on the original signal and the noise,
wherein the repetition signals represent an input signal that is continuously repeated in a designated interval.

12. The apparatus as claimed in claim 11, wherein the controller comprises:
an index detection unit for detecting the index signal;
an original signal detection unit for re-arranging the repetition signals in the designated interval in which the input signal is continuously repeated, for calculating an average value of the re-arranged repetition signals, and for detecting the original signal of a noise-removed repetition signal;
a noise detection unit for detecting noise of the repetition signals based on a difference between the original signal and the repetition signals; and
a signal-to-noise ratio calculation unit for calculating a signal-to-noise ratio of the input signal, based on the original signal and the noise.

13. The apparatus as claimed in claim 12, wherein the signal-to-noise ratio calculation unit calculates the signal-to-noise ratio of the input signal, using the following equation:
SNR=10 log₁₀(average_{sig})²/(average_{sig}−input_{sig})²,
wherein SNR represents the signal-to-noise ratio of the input signal, average_{sig} represents the original signal as an average value of the re-arranged repetition signals, and input_{sig} represents the repetition signals used for detecting the original signal.

14. The apparatus as claimed in claim 12, wherein the index signal is a unique signal longer than a basic length of unit data that is added to each repeated intervals in which repetition signals occur.

15. The apparatus as claimed in claim 12, wherein the signal-to-noise ratio calculation unit calculates the signal-to-noise ratio of the input signal, using the following equation:
SNR=10 log₁₀(average_{sig})²/(noise)²,
wherein SNR represents the signal-to-noise ratio of the input signal, average_{sig} represents the original signal as an average value of the re-arranged repetition signals, and noise represents noise contained in the repetition signals.
